(19) United States
(12) Patent Application Publication
(10) Pub. No.: US 2011/0084126 A1
(43) Pub. Date: Apr. 14, 2011

(54) METHODS AND SYSTEMS FOR ENHANCING READ ACCURACY IN AUTOMATED LICENSE PLATE READER SYSTEMS

(75) Inventors: Patrick R. Fleming, Lake Elmo, MN (US); Thomas J. Dahlin, St. Louis Park, MN (US)

(73) Assignee: 3M Innovative Properties Company

(21) Appl. No.: 12/575,776

(22) Filed: Oct. 8, 2009

(51) Int. Cl. G06F 17/00; G06K 19/06; G09F 7/00

(52) U.S. Cl. 235/375; 235/494; 40/200

(57) ABSTRACT

The systems, methods, and apparatuses of the present disclosure generally describe the use of one or both of human-readable information and machine-readable information printed on, adhered to, or adjacent to an object (e.g., a license plate or sticker), where at least a portion of the machine-readable information performs or assists in performance of at least one of the following functions: (a) correlating to license plate information stored in a remote lookup table; and (b) duplicating information about the license plate.

### TECHNICAL FIELD

The present disclosure generally relates to methods, apparatuses, and systems for enhancing read accuracy in an automated license plate reader system.

### BACKGROUND

Automatic Vehicle Recognition (AVR) is a term applied to the detection and recognition of a vehicle by an electronic system. Exemplary uses for AVR include, for example, automatic tolling, traffic law enforcement, searching for vehicles associated with crimes, and facility access control. Ideal AVR systems are universal (i.e., they are able to read all vehicles with 100% accuracy). The two main types of AVR systems in use today are (1) systems using RFID technology to read an RFID tag attached to a vehicle and (2) systems using a machine or device to read a machine-readable code attached to a vehicle.

One advantage of RFID systems is their high accuracy, which is achieved by virtue of error detection and correction information contained on the RFID tag. Using well known mathematical techniques (cyclic redundancy check, or CRC, for example), the probability that a read is accurate (or the inverse) can be determined. However, RFID systems have some disadvantages, including that not all vehicles include RFID tags. Also, existing unpowered “passive” RFID tag readers cannot pinpoint the exact location of an object. Rather, they simply report the presence or absence of a tag in their field of sensitivity. Moreover, many RFID tag readers only operate at short range, function poorly in the presence of metal, and are blocked by interference when many tagged objects are present. Some of these problems can be overcome by using active RFID technology or similar methods. However, these techniques require expensive, power-consuming electronics and batteries, and they still may not determine position accurately when attached to dense or metallic objects.

Machine vision systems (often called Automated License Plate Readers or ALPR systems) use a machine or device to read a machine-readable code attached to a vehicle. In many embodiments, the machine readable code is attached to, printed on, or adjacent to a license plate. One exemplary ALPR system is shown schematically in FIG. 1, which illustrates the process of illuminating and viewing a retroreflective tag. The term “retroreflective” as used herein refers to the attribute of reflecting an obliquely incident light ray in a direction antiparallel to its incident direction, or nearly so, such that it returns to the light source or the immediate vicinity thereof. An infra-red (“IR”) light source 106 illuminates a retroreflective tag 102, which is located on a license plate 104. Retroreflective tag 102 reflects the IR light emitted by light source 106 straight back to the IR light source 106, where it is captured by an IR sensor 108, such as, for example, an IR camera. One advantage of ALPR systems is that they are can be used almost universally, since almost all areas of the world require that vehicles have license plates with visually identifiable information thereon. However, the task of recognizing visual tags can be complicated. For example, the read accuracy from an ALPR system is largely dependent on the quality of the captured image as assessed by the reader. Existing systems have difficulty distinguishing tags from complex backgrounds and handling variable lighting. Further, the accuracy of ALPR systems suffers when license plates are obscured or dirty.

Some exemplary ALPR systems include a bar code (or other machine-readable portion) containing “an identification code which will provide information about the vehicle,” as is described in PCT Publication No. 2008/007076 to Retainagroup Ltd. Typically, the bar code on a license plate includes inventory control information (i.e., a small bar code not intended to be read by the ALPR). Some publications (e.g., European Patent Publication No. 0416742 and U.S. Pat. No. 6,832,728) discuss including one or more of owner information, serial numbers, vehicle type, vehicle weight, plate number, state, plate type, and county on a machine-readable portion of a license plate.

### SUMMARY

The present inventors recognized the need for methods, apparatuses, and systems for identifying an object without the above-described problems. The present inventors also recognized the need for methods, apparatuses, and systems for increasing the read accuracy of an ALPR system.

The present inventors recognized that license plate read accuracy could be enhanced through the inclusion of both human-readable information and machine-readable information on a license plate where the machine-readable information correlates to license plate information stored in a lookup table. Consequently, some preferred embodiments of the present disclosure relate to an object comprising: human-readable information and machine-readable information; and at least a portion of the machine-readable information correlating to license plate information stored in a lookup table. Other preferred embodiments of the present disclosure relate to a sticker capable of attachment to a license plate including human-readable information, the sticker comprising: machine-readable information, at least a portion of which correlates to license plate information stored in a lookup table. Other preferred embodiments of the present disclosure relate to a license plate, comprising: human-readable information and machine-readable information; and at least a portion of the machine-readable information correlating to license plate information stored in a remote lookup table.

The present inventors also recognized that license plate read accuracy could be enhanced by the inclusion of both human-readable information and machine-readable information on a license plate where the machine-readable information duplicates or replicates information in, on, or about the license plate. Consequently, some preferred embodiments of the present disclosure relate to an object comprising: human-readable information and machine-readable information; and at least a portion of the machine-readable information duplicating information in, on, or about the license plate. Other preferred embodiments of the present disclosure relate to a sticker capable of attachment to a license plate including human-readable information, the sticker comprising: machine-readable information, at least a portion of which duplicates information in, on, or about the license plate. Other preferred embodiments of the present disclosure relate to a license plate, comprising: human-readable information and machine-readable information; and at least a portion of the machine-readable information duplicating information in, on, or about the license plate.

In preferred implementations of the above-described embodiments, the human-readable information and the machine-readable information is printed on, adhered to, or positioned adjacent to at least a portion of the license plate. In preferred implementations of the above-described embodiments, the human-readable information includes one or more of alphanumeric characters and designs. In preferred implementations of the above-described embodiments, the machine-readable information includes one or more of a bar code, a 2D bar code, a geometric symbol as described in European Publication No. 0416742, and the like.

Other preferred embodiments of the present disclosure relate to an ALPR system, comprising: (1) a license plate comprising: human-readable information and machine-readable information, wherein at least a portion of the machine-readable information assists in at least one of (a) correlating to license plate information stored in a remote lookup table; and (b) duplicating information about the license plate; (2) a machine capable of reading the machine-readable information; and (3) a processing unit that detects the performs the at least one of (a) and (b).

Other preferred embodiments of the present disclosure relate to methods of enhancing the accuracy of license plate readings. One exemplary method comprises: (1) providing a license plate comprising: human-readable information and machine-readable information; (2) reading at least one of the human-readable information and machine-readable information; and (3) using the machine-readable information to assist in at least one of (a) correlating to license plate information stored in a remote lookup table; and (b) duplicating information about the license plate.

### BRIEF DESCRIPTION OF DRAWINGS

FIG. 1 is a schematic of a prior art ALPR system.

FIG. 2A is photograph of an exemplary license place including a bumper sticker on which is printed a bar code.

FIG. 2B is a photograph of the license plate of FIG. 2A in infra-red light.

FIG. 3A is a photograph of an exemplary license plate including a sticker as it appears in visible light.

FIG. 3B is a photograph of the license plate of FIG. 3A in infra-red light.

FIG. 4A is a photograph of an exemplary license plate including a frame or cover on which is printed machine-readable information as it appears in visible light.

FIG. 4B is a photograph of the license plate of FIG. 4A in infra-red light.

FIG. 5A is a photograph of an exemplary license plate including a frame or cover on which is printed machine-readable information as it appears in visible light.

FIG. 5B is a photograph of the license plate of FIG. 5A as it appears in infra-red light.

FIG. 6A is a photograph of an exemplary license plate including a frame or cover on which is printed machine-readable information as it appears in visible light.

FIG. 6B is a photograph of the license plate of FIG. 6A as it appears in infra-red light.

FIG. 7A is a photograph of license plate including a frame or cover on which is printed machine-readable information as it appears in visible light.

FIG. 7B is a photograph of the license plate of FIG. 7A as it appears in infra-red light.

FIG. 8A is a photograph of an exemplary license plate including machine-readable information printed directly on or adhered to a license plate or license plate sheeting as it appears in visible light.

FIG. 8B is a photograph of the license plate of FIG. 8A as it appears in infra-red light.

FIG. 9A is a photograph of an exemplary license plate including machine-readable information printed directly on or adhered to a license plate or license plate sheeting as it appears in visible light.

FIG. 9B is a photograph of the license plate of FIG. 9A as it appears in infra-red light.

FIG. 10A is a photograph of an exemplary license plate including machine-readable information printed directly on or adhered to a license plate or license plate sheeting as it appears in visible light.

FIG. 10B is a photograph of the license plate of FIG. 10A as it appears in infra-red light.

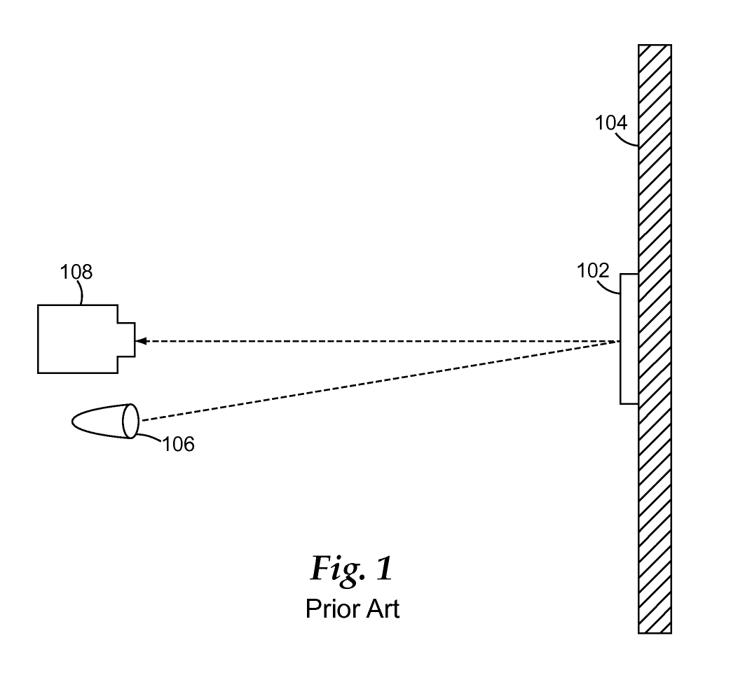

### DETAILED DESCRIPTION

The systems, methods, and apparatuses of the present disclosure generally describe the use of human-readable information and machine-readable information printed on, adhered to, or adjacent to an object, where at least a portion of the machine-readable information performs or assists in the performance of at least one of the following functions: (a) correlating to license plate information stored in a remote lookup table; and (b) duplicating information about the license plate. Exemplary objects include, but are not limited to, vehicles (e.g., trains, planes, automobiles, and boats), packages, shipping containers, license plates, stickers, and security documents. When referring to “reading,” “reads,” or “read accuracy,” applicant means the machine interpretation of the human-readable or machine-readable information contained on an object, such as, for example, a license plate. The following will be discussed with respect to license plates and stickers, but the present disclosure is meant to include objects other than license plates and stickers.

I. ALPR Systems in which the Machine-Readable Information Correlates to License Plate Information Stored in a Lookup Table

Optimally, license plates have an overall similarity of styling or appearance that enables rapid recognition of license plates issued by various licensing authorities and that inhibits counterfeiting. At the same time, license plates should provide a distinct, individualized, and unique identifying code or image for each vehicle, state, or driver. To that end, many licensing authorities offer “vanity” license plates. Such plates allow the driver to select an attractive or meaningful design that will be printed on their license plate. The production of such “vanity” license plates results in each state offering numerous different license plate designs to its constituents.

The proliferation of these individualized license plates is significant. For example, the state of Oregon offers seven different license plate design options to standard vehicle drivers: tree, salmon, Crater Lake, cultural trust, amateur radio operator (ham), antique vehicle, and special interest. Also, the state of Oregon offers six types of non-profit plates to standard vehicle drivers: Lions Club, Oregon Masonic Family, Oregon Professional Firefighters, Oregon State Elks, Share the Road, and Support Our Troops plates. Additionally, the state of Oregon offers six types of high education plates to drivers of standard vehicles: Eastern Oregon University, Oregon State University, Portland State University, University of Oregon, University of Portland, and Willamette University. Further, the state of Oregon offers ten veteran and service-related plates to drivers of standard vehicles: Congressional Medal of Honor; Disabled Veteran; Ex-POW; First Marine Division; Gold Star Family; National Guard; Non-Commission Officers Association; Purple Heart; Veterans Recognition; and Vietnam Veterans. This results in a total of 33 different personalized plate options for standard vehicles in a single state. If each of the 50 states and each of the 10 Canadian provinces offer approximately the same number of options for standard vehicles, almost 2000 different design options for license plates are available. This does not even take into account the license plate options for mopeds, motorcycles, campers, trailers, trucks, commercial vehicles, government vehicles, dealer vehicles, and motor homes.

Meanwhile, automated enforcement systems, including, for example, electronic toll systems, red light running systems, speed enforcement systems, and access control systems are becoming more prevalent. Many embodiments of such systems rely on an accurate reading of a vehicle's license plate, which is often performed by an ALPR system. However, obtaining an accurate reading of a vehicle's license plate is becoming increasingly difficult due to the wide variety of license plates now on the roads. Further complicating this is the fact that each license plate may use a different font, and font misinterpretation is a common error in ALPR systems.

The inventors of the present disclosure recognized these needs and invented an ALPR system including a license plate with human-readable information (e.g., alphanumeric characters and/or designs) and machine-readable information wherein at least a portion of the machine-readable information correlates to information contained in a look-up table that assists the ALPR system in accurately reading the license plate.

As used herein, the term “human-readable information” refers to information visible to the naked human eye and interpretable by the average person. Exemplary types of human-readable information include, but are not limited to, alphanumeric characters and/or symbols. The human-readable information can be formed on a license plate, can be formed on license plate sheeting, can be adhered to a license plate, can be formed on a cover or frame positioned adjacent to the license plate, can be adhered to a cover or frame adjacent to the license plate, or can be otherwise affixed to the object.

As used herein, the term “machine-readable information” refers to printed information that is encoded in a form that can be imaged and/or scanned by a machine or computer and interpreted by its hardware and software. Theoretically, anything that can be read by a human can also be read by a machine, although it may not necessarily be comprehended by a human. Exemplary types of machine-readable codes include, for example, bar codes, 2D bar codes, geometric symbols as described in European Publication No. 0416742 and the like. The machine-readable information can be, for example, visible or invisible to the human eye. Machine-readable codes can be made invisible to the human eye by, for example, wavelength shifting, use of specific lighting conditions, IR absorbing dyes, multi-layer optical films, and the like. The machine-readable portion can be formed directly on the vehicle, can be formed on the license plate, can be adhered to the license plate, can be formed on a cover or frame adjacent to the license plate, can be adhered to a cover or frame adjacent to the license plate, or otherwise affixed to the object.

In one exemplary implementation of such an ALPR system, license plates include human-readable information in the form of a license plate design, state name, and license identifier as well as machine-readable information in the form of a bar code on or adjacent to the license plate. At least some of the information in the bar code relates to license plate information stored in a look-up table. For example, a bar code on a license plate is read by an IR camera as it travels through a designated area. The bar code includes look-up information that tells the processing center that the license plate is an Oregon license plate and that, more specifically, it is an Oregon Masonic Family license plate. The processing center can then reference a look-up table that includes the “rules” relating to the Oregon Masonic Family license plates. These rules may include things like the font of the alphanumerics on Oregon Masonic Family license plates, the number of alphanumeric characters on Oregon Masonic Family license plates, the spacing and height of the alphanumeric characters on Oregon Masonic Family license plates, and whether the alphanumerics include, for example, seriffs, etc. Once the system knows these rules, it can more accurately read the alphanumerics on the license plate.

Those of skill in the art will appreciate that many changes may be made to the exemplary implementations described above without departing from the scope of the present disclosure. For example, the look-up table can be stored remotely or stored in the machine or device (e.g., camera) that reads the bar code.

II. ALPR Systems in which the Machine-Readable Information Duplicates the Information on the License Plate

As described above, license plates get dirty with regular use. ALPR systems often rely on visual identification of the human-readable alphanumerics on a license plate in order to read the license plate. When these alphanumerics are dirty, their visibility and clarity is significantly compromised, often resulting in inaccurate license plate reads.

To address at least some of these concerns, the inventors of the present disclosure invented an ALPR system that is capable of reading a license plate having both human-readable information and machine-readable information, where the machine-readable information includes a duplication or replication of the human-readable information. This significantly increases the probability that the license plate information is accurately read because the machine-readable information provides a self-check of the human-readable information on or adjacent to the license plate.

Duplication or replication of the human-readable information on a license plate can be difficult to accomplish because of the large number of machine-readable bits required to replicate or duplicate all of the human-readable information (e.g., license plate state, license plate type, license plate number or identifier, license plate graphics, license plate issuance year and/or month, etc.). However, the available space on a license plate for machine-readable information is limited because most of the space on existing plates is already filled with human-readable information. Also, there is a desire not to overcrowd the license plate with information so that it remains both legible and aesthetically pleasing. The inventors of the present disclosure invented ways to place relatively large amounts of machine-readable information on license plates.

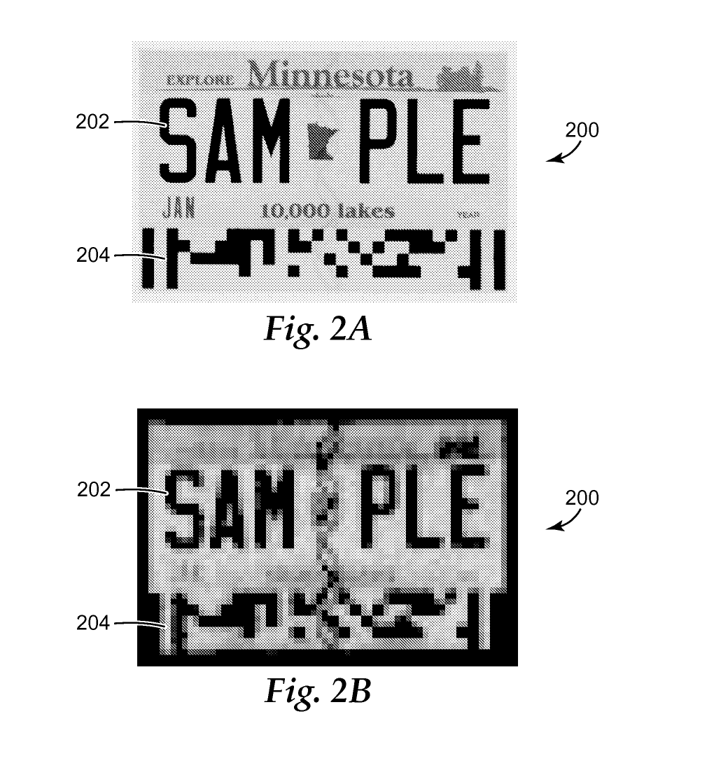

In one exemplary implementation, shown in FIG. 2A, machine-readable information 200 (here shown in the form of a bar code) is included on a bumper sticker 202 adjacent to a license plate 204. FIG. 2B shows that bar code 200 can also be read under infra-red light. By including the machine-readable information in a bumper sticker, the license plate graphics are not cluttered or obscured and remain aesthetically pleasing. Also, the bar code can be of sufficient size to permit the duplication or replication of all of the human-readable information on the license plate.

Those of skill in the art will appreciate that many changes may be made to the exemplary implementation described above without departing from the scope of the present disclosure. For example, the machine-readable information can include only some of the human-readable information or can include all of the human-readable information as well as additional information. Also, the bar code size can vary, and the bar code can be adhered directly to or printed directly on the license plate rather than being on a bumper sticker.

All of the above-described embodiments can be accomplished in various ways, some of which are described and shown below.

A. Implementations in which a Sticker Includes the Machine-Readable Information

In some exemplary implementations, a sticker including the machine-readable information is adhered to a license plate including a human-readable alphanumeric license plate number/identifier. One advantage of putting the machine-readable information on a sticker is that existing license plates can be renewed and updated by reissuing only the stickers, thereby avoiding the expense and hassle of reissuing all of the license plates. Additionally, in at least some implementations, the machine-readable information would make the stickers plate-specific such that the sticker would not work if it was, for example, stolen in the mail and placed on another plate. Another advantage is that the sticker can be sized to ensure that the license plate is aesthetically pleasing.

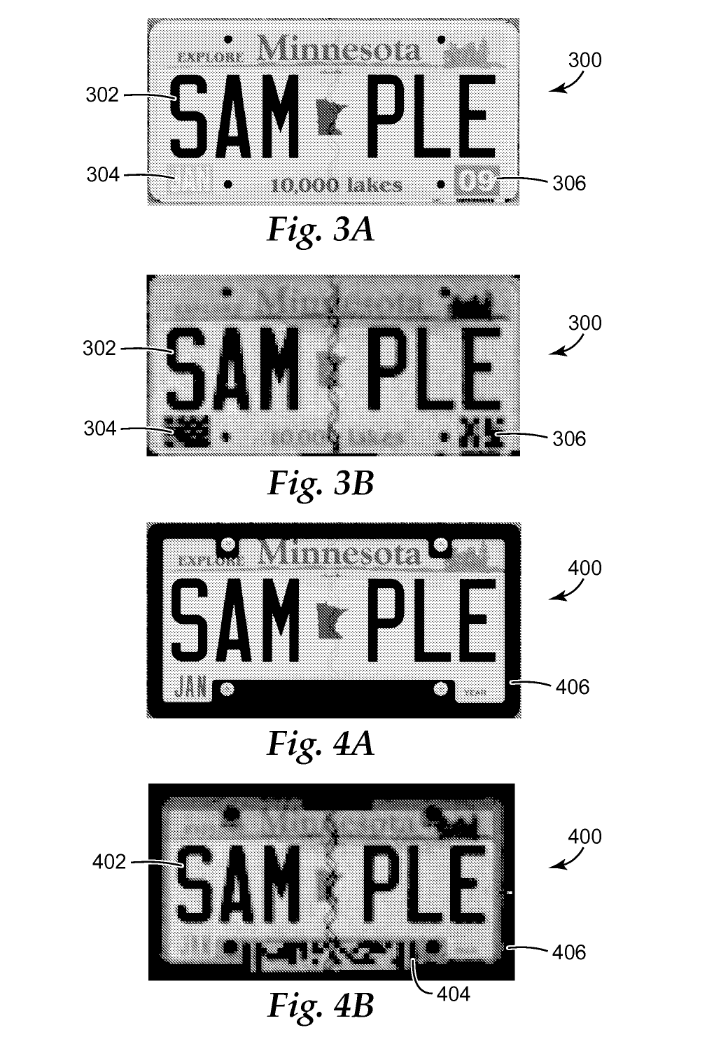

In some exemplary implementations, the sticker on which the machine-readable information is printed as a registration sticker. One example of a license plate including such stickers is shown in FIGS. 3A and 3B. FIG. 3A shows an exemplary license plate 300 including human-readable information 302 (“SAM PLE” and “Explore Minnesota”) and machine-readable information 304, 306 in the form of registration stickers. Sticker 304 is blue with white letters spelling “JAN,” and sticker 306 is pink with the following numbers in white “09.” All of this information is visible to a human in visible light. However, when the license plate is viewed in infra-red light, registration stickers 304 and 306 do not show the human-readable information but instead show machine-readable information. FIG. 3B shows license plate 300 as viewed under infra-red light. Stickers 304 and 306 appear as bar codes, at least one of which includes error correction and/or error detection codes. Those of skill in the art will appreciate that many changes may be made to the exemplary implementations described above without departing from the scope of the present disclosure.

By printing the bar code on the registration sticker, one can avoid cluttering the already full license plate. This is especially useful for license plates in the United States where there is little room on existing license plates for additional stickers, because most of the license plate is used for the large alphanumeric characters that form the license plate number or identifier, renewal stickers, and/or plate holders/covers/frames. Additionally, the individual pixels in the bar code on the sticker must be of a size that permits adequate resolution by the machine or device (e.g., camera) that reads the bar code. Typical commercially available ALPR systems use cameras that can accurately read approximately 2000 pixels per line, covering approximately 15 feet of lane width, translating to approximately 144 pixels per foot (12 pixels per inch), or a minimum detectable feature of about 0.17 inches (2 pixels).

Typical registration stickers in the United States measure approximately 1 to 1.5 square inches, meaning that they can include approximately 35 bits, of which approximately 16-24 bits of data is non-framing or timing data (assuming that approximately twelve bits of data are used for framing and timing, 23 bits of data can be used for the error detection and/or correction). For a 1 inch sticker including only the framing bits, timing bits, and error detection/correction bits, the confidence level for license plate read accuracy can be improved to better than 99.999% when both the plate number and the bar code are correctly read (4 timing bits+2 framing bits+10 information bits=2²³ possibilities). The current annual renewal stickers are about 1.5 square inches. For a 1.5 inch sticker including only the framing bits, timing bits, and error correction and/or detection bits, the confidence level for license plate read accuracy can be improved even more when both the plate number and the bar code are correctly read.

B. Implementations in which a Frame or Cover Includes the Machine-Readable Information

In some exemplary implementations, the machine-readable information (e.g., a bar code) is printed on or adhered to a frame or cover that is positioned adjacent to the license plate. By printing the bar code on or adhering the bar code to the frame or cover, one can avoid cluttering the already full license plate. This is especially useful for license plates in the United States for the reasons described above. In embodiments where the bar code is printed on the cover or frame, the bar code can be printed on either the front or back surface of the frame or cover.

Various examples of a license plate that includes machine-readable information (e.g., a bar code) on a frame or cover are shown in FIGS. 4A-7B. FIG. 4A shows an exemplary license plate 400 as viewed by the human eye in visible light. License plate 400 includes human-readable information 402 (“SAM PLE” and “Explore Minnesota”) and a frame or cover 406. FIG. 4B shows license plate 400 as viewed under infra-red light. When viewed under infra-red light, frame 406 includes an IR-visible bar code 404.

One advantage of the exemplary license plate implementation shown in FIGS. 4A and 4B is that it is uncluttered and aesthetically pleasing. Further, this exemplary license plate implementation is difficult to tamper with in that because the bar code is not visible to the human eye, the average person does not know that the bar code is present and thus is prevented from tampering with it. Further, most frames or covers provide a larger area in which to print the bar code than a registration or other sticker, so the bar code can include more information/bits than the license plate implementations including a sticker (making it appropriate for the embodiments in which the human-readable information is replicated or duplicated). For example, using the read range, camera resolution, and pixel size described above for typical ALPR systems and cameras, bar code 404 could include approximately 150 bits of information. The more information that can be detected and processed, the greater the degree of confidence that the license plate was accurately read.

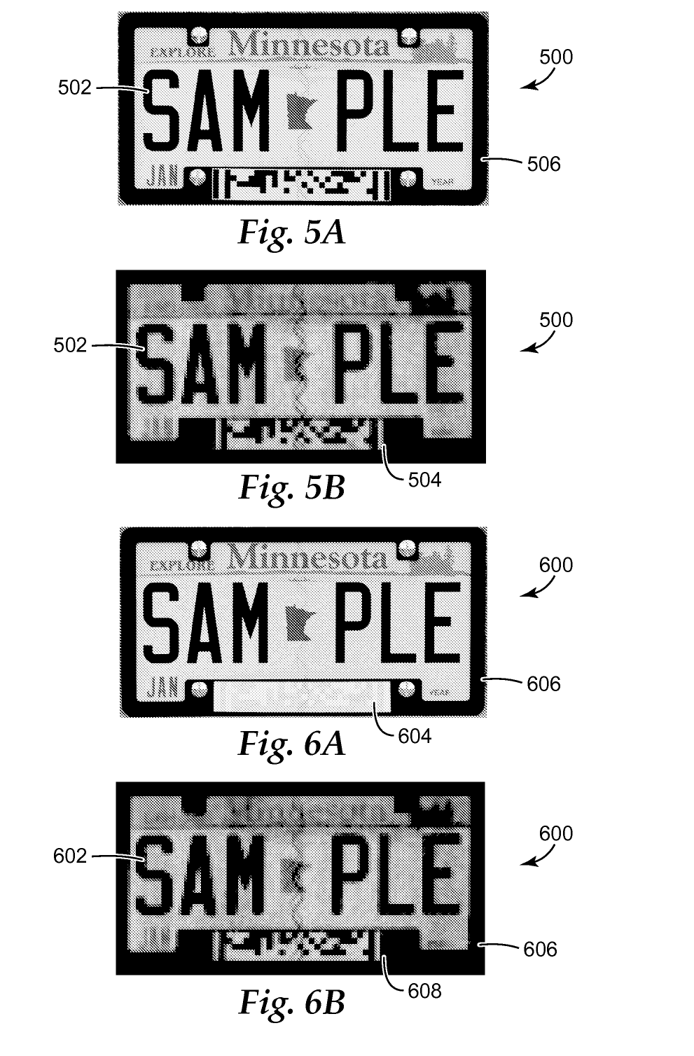

FIG. 5A shows an exemplary license plate 500 as viewed by the human eye under visible light. License plate 500 includes human-readable information 502 (“SAM PLE” and “Explore Minnesota”) and a frame or cover 506 onto which has been printed or affixed a bar code 504 that is visible to the naked human eye under visible light. FIG. 5B shows license plate 500 as viewed under infra-red light. When viewed under infra-red light, bar code 504 on frame 506 is visible.

FIG. 6A shows an exemplary license plate 600 as viewed by the human eye under visible light. License plate 600 includes human-readable information 602 (“SAM PLE” and “Explore Minnesota”) and a frame or cover 606 onto which has been printed or affixed a white sticker 604 that is visible to the naked human eye under visible light. FIG. 6B shows license plate 600 as viewed under infra-red light. When viewed under infra-red light, a bar code 608 on sticker 604 is visible.

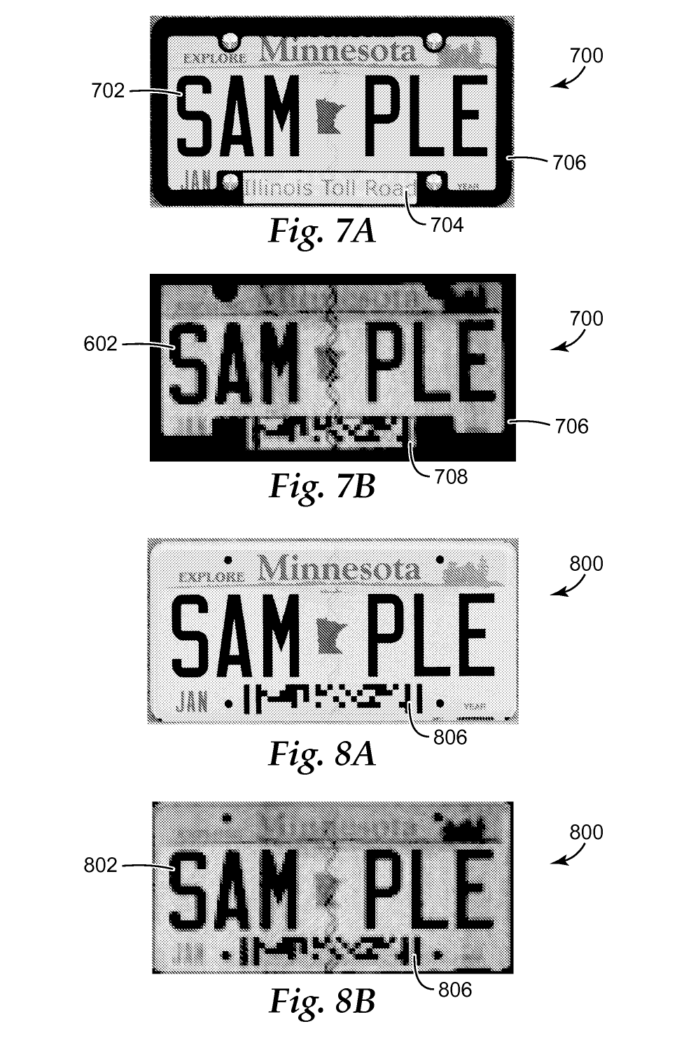

FIG. 7A shows an exemplary license plate 700 as viewed by the human eye under visible light. License plate 700 includes human-readable information 702 (“SAM PLE” and “Explore Minnesota”) and a frame or cover 706 onto which has been printed or affixed a white sticker 704 that is visible to the naked human eye under visible light and onto which is printed in red “Illinois Toll Road.” FIG. 7B shows license plate 700 as viewed under infra-red light. When viewed under infra-red light, a bar code 708 on sticker 704 is visible.

Those of skill in the art will appreciate that many changes may be made to the exemplary implementations described above without departing from the scope of the present disclosure. For example, the location of the bar code on the license plate frame or cover can vary, as the locations shown in FIGS. 4A-7B were merely exemplary.

C. Implementations in which the Machine-Readable Information is Printed on the License Plate

In some exemplary implementations, the machine-readable information is printed on or adhered to the license plate or to license plate sheeting. By printing the bar code on or adhering the bar code directly to the license plate or license plate sheeting, one can ensure that the bar code and the license plate identifier match. Further, these implementations also avoid cluttering the already full license plate while providing sufficient machine or device readability. This is especially useful for license plates in the United States for the reasons described above.

Various examples of a license plate that includes machine-readable information (e.g., a bar code) directly on the license plate or license plate sheeting are shown in FIGS. 8A-10B. FIG. 8A shows an exemplary license plate 800 as viewed by the human eye under visible light. License plate 800 includes human-readable information 802 (“SAM PLE” and “Explore Minnesota”) and a bar code 806 that is printed directly on or adhered to license plate 800 and that is visible to the naked human eye under visible light. FIG. 8B shows license plate 800 as viewed under infra-red light. When viewed under infra-red light, bar code 806 is visible.

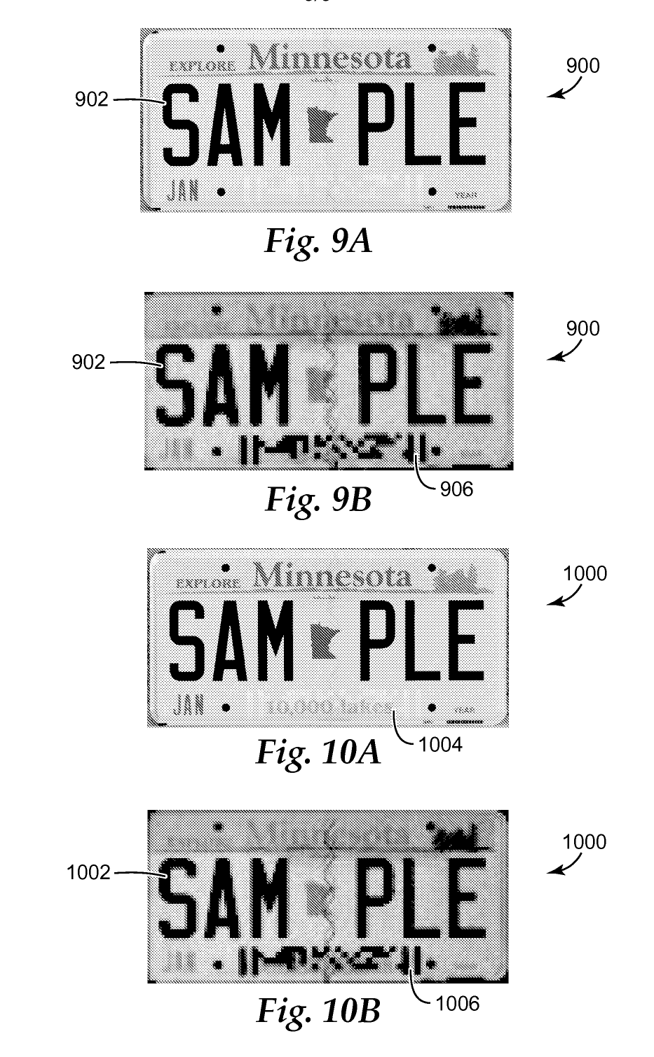

FIG. 9A shows an exemplary license plate 900 as viewed by the human eye under visible light. License plate 900 includes human-readable information 902 (“SAM PLE” and “Explore Minnesota”). FIG. 9B shows license plate 900 as viewed under infra-red light. When viewed under infra-red light, a bar code 906 is visible. Bar code 906 is printed directly on or adhered to license plate 900 and is not visible to the naked human eye under visible light.

FIG. 10A shows an exemplary license plate 1000 as viewed by the human eye. License plate 1000 includes human-readable information 1002 (“SAM PLE”) and 1004 (“10,000 Lakes”). FIG. 10B shows license plate 1000 as viewed under infra-red light. When viewed under infra-red light, area 1004 is shown to include a bar code 1006. Bar code 1006 is printed directly on or adhered to license plate 1000 and is not visible to the naked human eye under visible light but is visible under infra-red light.

III. ALPR Systems Including the License Plates Described Above

The license plates and/or stickers described above can be used in any ALPR system. One specific, exemplary implementation of such an ALPR system includes a license plate of the type described above; a machine capable of reading the machine-readable information; and a processing unit that processes the machine-readable. The machine capable of reading the machine-readable information can be, for example, a camera. One exemplary commercially available camera commonly used in ALPR systems is Model 383, Spike™ sold by PIPS Technology, a division of Federal Signal Company. The processing unit can be, for example, a computer or the software in the camera. Those of skill in the art will recognize how to program the software in operation in the processing unit to detect, correlate, and process the error detection and/or error correction codes described above. The data structures and code described herein are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs).

IV. Methods of Enhancing ALPR System Confidence in the Accuracy of a License Plate Read

The present disclosure also relates to methods of enhancing the accuracy of license plate reading. One exemplary method involves (1) providing a license plate of one of the types described above and (2) reading at least one of the human-readable information and machine-readable information.

The recitation of all numerical ranges by endpoint is meant to include all numbers subsumed within the range (i.e., the range 1 to 10 includes, for example, 1, 1.5, 3.33, and 10).

Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims.

What is claimed is:

1. An object comprising:
human-readable information and machine-readable information; and
at least a portion of the machine-readable information used to perform least one of (a) correlation to information stored in a lookup table; and (b) duplication of information in, on, or about the object.

2. The object of claim 1, wherein the human-readable information and the machine-readable information is printed on, adhered to, or adjacent to at least a portion of the object.

3. The object of claim 1, wherein the human-readable information includes one or more of alphanumeric characters and designs.

4. The object of claim 1, wherein the machine-readable information includes one or more of a bar code, a 2D bar code, a geometric symbol, and the like.

5. A sticker capable of attachment to a license plate including human-readable information, the sticker comprising:
machine-readable information, at least a portion of which is used to perform at least one of (a) correlation to license plate information stored in a lookup table; and (b) duplication of information in, on, or about the license plate.

6. The sticker of claim 5, wherein the human-readable information and the machine-readable information is printed on, adhered to, or adjacent to at least a portion of the license plate.

7. The sticker of claim 5, wherein the human-readable information includes one or more of alphanumeric characters and designs.

8. The sticker of claim 5, wherein the machine-readable information includes one or more of a bar code, a 2D bar code, a geometric symbol, and the like.

9. A license plate, comprising:
human-readable information and machine-readable information; and
at least a portion of the machine-readable information used to perform at least one of (a) correlation to license plate information stored in a lookup table; and (b) duplication of information in, on, or about the license plate.

10. The license plate of claim 9, wherein the human-readable information and the machine-readable information is printed on, adhered to, or adjacent to at least a portion of the license plate.

11. The license plate of claim 9, wherein the human-readable information includes one or more of alphanumeric characters and designs.

12. The license plate of claim 9, wherein the machine-readable information includes one or more of a bar code, a 2D bar code, a geometric symbol, and the like.

13. An ALPR system, comprising:
(1) a license plate comprising:
human-readable information and machine-readable information, wherein at least a portion of the machine-readable information is used to perform at least one of (a) correlating to license plate information stored in a remote lookup table; and (b) duplicating information about the license plate;
(2) a machine capable of reading the machine-readable information; and
(3) a processing unit that detects the performs the at least one of (a) and (b).

14. A method of enhancing the accuracy of license plate readings, comprising:
(1) providing a license plate including human-readable information and machine-readable information;
(2) reading at least one of the human-readable information and machine-readable information; and
(3) using the machine-readable information to effect at least one of
(a) correlating to license plate information stored in a remote lookup table; and
(b) duplicating information about the license plate.
